(19) United States
(12) Patent Application Publication
(10) Pub. No.: US 2021/0178406 A1
(43) Pub. Date: Jun. 17, 2021

(54) 3D PRINTING SYSTEM WITH CYLONE SEPARATOR

(71) Applicant: HEWLETT-PACKARD DEVELOPMENT COMPANY, L.P., Spring, TX (US)

(72) Inventors: Steve RINGWALD, Corvallis, OR (US); David R. OTIS, Jr., Corvallis, OR (US)

(73) Assignee: HEWLETT-PACKARD DEVELOPMENT COMPANY, L.P., Houston, TX (US)

(21) Appl. No.: 16/077,085

(22) PCT Filed: Jul. 27, 2017
(86) PCT No.: PCT/US2017/044202

§ 371 Date: Aug. 10, 2018

(51) Int. Cl. B04C 5/13; B04C 5/081; B04C 11/00; B29C 64/321; B29C 64/357; B65G 53/60

(52) U.S. Cl. CPC B04C 5/13; B04C 5/081; B04C 11/00; B33Y 40/00; B29C 64/357; B65G 53/60; B29C 64/321

(57) ABSTRACT

According to examples, a 3D printing system may include a feed line to receive build material particles from a material bin, an air pressure generator to generate airflow inside the feedline to move the build material particles through the feedline, and a cyclone separator to receive the airflow and the build material particles from the feed line and to separate the build material particles from the airflow. The cyclone separator may include a chamber wall, a build material particle discharge opening, and a tapered wall connecting the chamber wall and the build material particle discharge opening. In addition, a ratio between a diameter of the chamber and a diameter of the discharge opening may be between about 1.5 and about 4.0.

### BACKGROUND

In three-dimensional (3D) printing, an additive printing process is often used to make three-dimensional solid parts from a digital model. 3D printing is often used in rapid product prototyping, mold generation, mold master generation, and short-run manufacturing. Some 3D printing techniques are considered additive processes because they involve the application of successive layers of material to an existing surface (template or previous layer). This is unlike traditional machining processes, which often rely upon the removal of material to create the final part. 3D printing often requires curing or fusing of the building material, which for some materials may be accomplished using heat-assisted extrusion, melting, or sintering, and for other materials may be performed through curing of polymer-based build materials.

### BRIEF DESCRIPTION OF THE DRAWINGS

Features of the present disclosure are illustrated by way of example and not limited in the following figure(s), in which like numerals indicate like elements, in which:

FIG. 1A shows a diagram of an example 3D printing system that may include an example cyclone separator to separate build material particles from airflow;

FIG. 1B shows a diagram of the example cyclone separator depicted in FIG. 1A;

FIG. 2 shows a block diagram of an example 3D printing system; and

FIGS. 3 and 4, respectively, show flow diagrams of example methods for moving build material particles in a 3D printing system.

### DETAILED DESCRIPTION

Disclosed herein are 3D printing systems that may implement feed lines through which build material particles mixed with airflow may be moved from material bins to other locations in the 3D printing systems. A location in a 3D printing system may include, for instance, a hopper from which build material particles may be supplied to a spreader that is to spread the build material particles over a build platform. Another location may be a hopper from which build material particles may be supplied into a storage bin, e.g., reclaimed build material particles may be stored in a reclaimed material storage bin for reuse and/or storage. In any regard, the 3D printing systems disclosed herein may include a cyclone separator that may separate the build material particles from the mixture such that the separated build material particles may be stored in a hopper.

As discussed herein, the cyclone separator may receive the mixture of airflow and build material particles from the feed line and may separate the build material particles from the airflow. The cyclone separator may include a chamber wall, a build material particle discharge opening, and a tapered wall connecting the chamber wall and the build material particle discharge opening. A ratio between a diameter of the chamber and a diameter of the discharge opening may be between about 1.5 and about 4.0. The cyclone separator disclosed herein may have a relatively short height while also having a relatively large discharge opening to enable the build material particles to be separated and exhausted from the cyclone separator at a relatively fast rate. In one regard, therefore, the cyclone separator disclosed herein may fit within relatively tight spaces as may be available in 3D printing systems.

Before continuing, it is noted that as used herein, the terms “includes” and “including” mean, but is not limited to, “includes” or “including” and “includes at least” or “including at least.” The term “based on” means “based on” and “based at least in part on.”

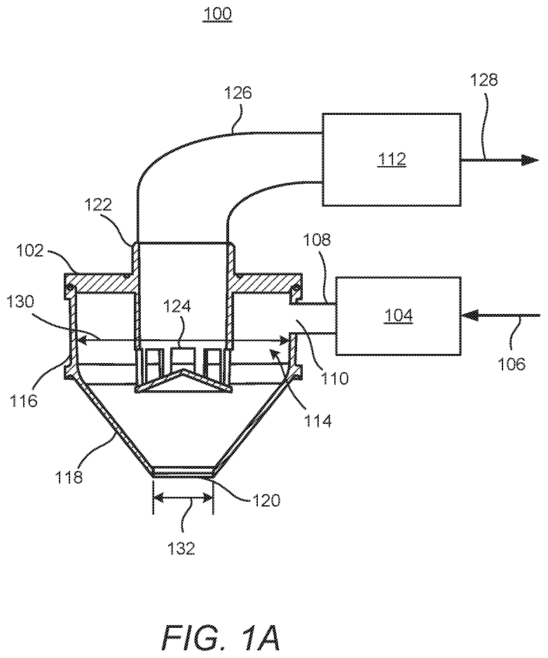

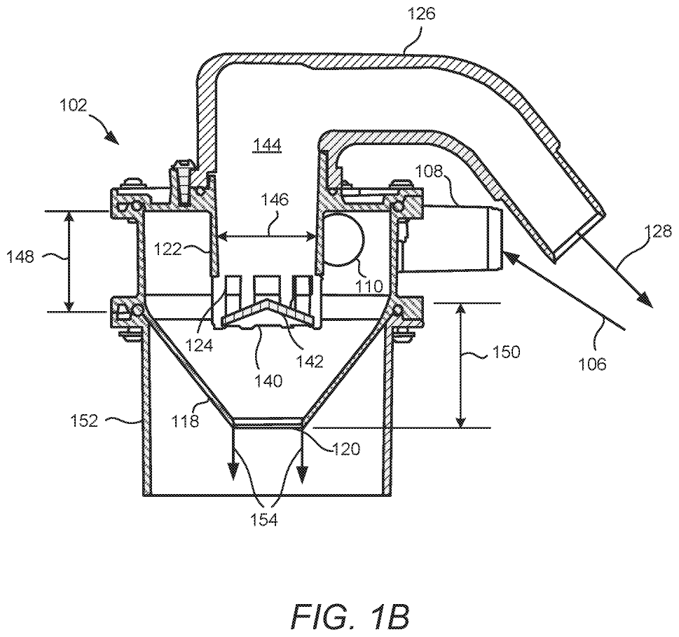

Reference is first made to FIGS. 1A and 1B. FIG. 1A shows a diagram of an example 3D printing system 100 that may include an example cyclone separator 102 to separate build material particles from airflow. FIG. 1B shows a diagram of the example cyclone separator 102 depicted in FIG. 1A. It should be understood that the 3D printing system 100 depicted in FIGS. 1A and 1B and the cyclone separator 102 depicted in FIG. 1B may include additional components and that some of the components described herein may be removed and/or modified without departing from scopes of the 3D printing system 100 and the cyclone separator 102 disclosed herein.

As shown in FIGS. 1A and 1B, the 3D printing system 100 may include a feed line 104 through which build material particles, as represented by the arrow 106, may be fed from a material bin (not shown) into the cyclone separator 102. Particularly, the feed line 104, which may be a conduit, a pipe, etc., may be attached to a feed member 108 that is attached to the cyclone separator 102. The feed member 108 may terminate at an inlet 110 of the cyclone separator 102. Generally speaking, the build material particles 106 may be delivered from the material bin to the cyclone separator 102 through mixing of the build material particles 106 with airflow and the cyclone separator 102 may separate the build material particles 106 from the airflow.

As also shown in FIG. 1A, the 3D printing system 100 may include an air pressure generator 112 to generate the airflow through the feed line 104. The air pressure generator 112 may be a fan, a blower, etc., and may pressurize the feed line 104 to generate airflow through the feed line 104. As the air flows through the feed line 104, build material particles 106 may be supplied into the airflow from the material bin. The supplied build material particles 106 may be mixed with the airflow in the feed line 104 such that the build material particles 106 may be delivered from the material bin to the cyclone separator 102.

The cyclone separator 102 may include features that are to cause the build material particles 106 to separate from the airflow. As shown, the chamber 114 may be formed of a chamber wall 201, which may have a circular cross-section at an upper section of the chamber 114 and a tapered wall 118 along a bottom section of the chamber 114. In addition, a discharge opening 120 may be formed at the bottom of the tapered wall 118. The cyclone separator 102 may also include an airflow exhaust member 122 having a plurality of openings 124 through which airflow may be exhausted from the chamber 114. In addition or in other examples, the cyclone separator 102 may be formed of a material that is at least one of anti-static, electrically conductive, triboelectrically similar to the materials, e.g., build material particles 106, being transported, etc., to reduce adhesion of the build material particles onto the walls of the cyclone separator 102.

In operation, the air pressure generator 112 pressurizes the feed line 104, which may cause the mixture of airflow and the build material particles 106 to be fed into the chamber 114 of the cyclone separator 102. In some examples, the velocity of the airflow may be between around 10 m/sec and about 20 m/sec. In any regard, the shape of the cyclone separator 102, e.g., the chamber 114 and the tapered wall 118, may cause the mixture of airflow and build material particles 106 to swirl around inside the chamber 114. That is, the mixture of airflow and build material particles 106 may swirl around in the form of a cyclone, e.g., in a helical pattern, such that rotational effects inside the chamber 114 and gravity separate the build material particles 106 from the mixture. As the build material particles 106 separate from the mixture, the build material particles 106 may fall through the discharge opening 120. In addition, the airflow may flow out of the chamber through the openings 124 and through an airflow exhaust tube 126. The airflow may also be exhausted from the 3D printing system 100 as indicated by the arrow 128.

According to examples, the diameter 130 of the chamber 114 may be about 1.5 to about 4.0 times larger than the diameter 132 of the discharge opening 120. In other words, a ratio between the diameter 130 of the chamber 114 and the diameter 132 of the discharge opening 120 may be between about 1.5 and about 4.0. In some examples, the diameter 130 of the chamber 114 may be between 1.4 to 4.1 times larger than the diameter 132 of the discharge opening 120. By way of particular example, the diameter 130 of the chamber 114 may be about 3.6 times larger than the diameter 132 of the discharge opening 120.

As also shown in FIG. 1B, the airflow exhaust member 122 may include a first end 140 that extends into the chamber 114. The first end 140 may include an end cap 142 and the plurality of openings 124 (which are also referenced herein as apertures 124) that extend along the airflow exhaust member 122. The end cap 142 may have a conical shape that extends away from the discharge opening 120 and toward the airflow exhaust tube 126. The conical shape of the end cap 142 may facilitate the flow of airflow through the openings 124 through a hole 144 of the airflow exhaust member 122 while minimizing the flow of build material particles through the airflow exhaust member 122.

The hole 144 in the airflow exhaust member 122 may have a diameter 146. A ratio between the diameter 130 of the chamber 114 and the diameter 146 of the hole 144 in the airflow exhaust member 122 may be between about 2 and about 4. That is, for instance, the diameter 130 of the chamber 114 may be about 2 to about 4 times larger than the diameter 146 of the hole 144. By way of particular example, the diameter 130 of the chamber 114 may be 2.5 times larger than the diameter 146 of the hole 144. In addition, a ratio between a height 148 of the chamber 114 and a height 150 of the tapered wall 118 may be between about 0.7 and about 1.5. By way of particular example, the ratio between the height 148 of the chamber 114 and the height 150 of the tapered wall 118 may be about 0.8.

In terms of other dimensions, the diameter 130 of the chamber 114 may be about 7.9 times larger than a diameter of the inlet 110. The diameter 130 of the chamber 114 may be about 2.7 times larger than the height 148 of the chamber 114. In addition, the diameter 130 of the chamber 114 may be about 2.3 times larger than the height 150 of the tapered wall 118.

As also shown in FIG. 1B, a material output tube 152 may be attached to the cyclone separator 102 such that material, as represented by the arrows 154, expelled through the discharge opening 120 of the cyclone separator 102 may be directed to a desired location, e.g., a hopper. According to examples, the discharge opening 120 may have a diameter 132 that is between about 20 mm to about 40 mm. In a particular example, the discharge opening 120 may have a diameter 132 that is about 20 mm.

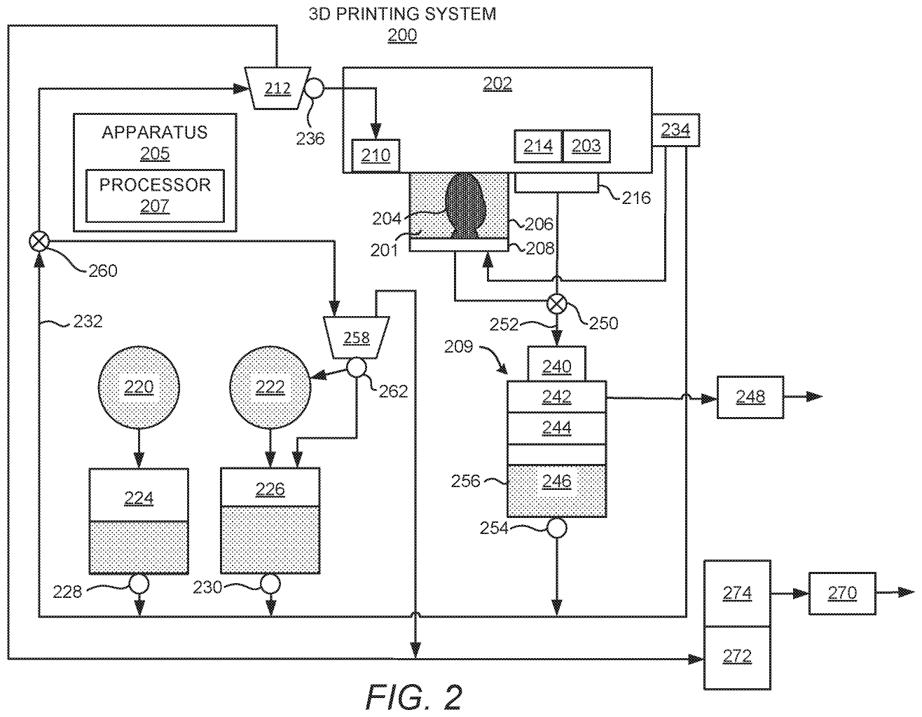

With reference now to FIG. 2, there is shown a block diagram of another example 3D printing system 200 in which the cyclone separator 102 disclosed herein may be implemented. It should be understood that the 3D printing system 200 depicted in FIG. 2 may include additional components and that some of the components described herein may be removed and/or modified without departing from a scope of the 3D printing system 200 disclosed herein. The description of FIG. 2 is made with reference to the elements shown in FIGS. 1A and 1B.

The 3D printing system 200 may include a build chamber 202 within which a 3D object 204 may be fabricated from build material particles 201 provided in respective layers in a build bucket 206. Particularly, a movable build platform 208 may be provided in the build bucket 206 and may be moved downward as the 3D object 204 is formed in successive layers of the build material particles 201. An upper hopper 212, which may include the cyclone separator 102 discussed above with respect to FIGS. 1A and 1B, may supply a spreader 210 with the build material particles 201 and the spreader 210 may move across the build bucket 206 to form the successive layers of build material particles 201. That is, the cyclone separator 102 may separate the build material particles 201 from the airflow and may supply the build material particles 201 to the spreader 210.

The build material particles 201 may be formed of any suitable material including, but not limited to, polymers, metals, and ceramics and may be in the form of a powder. Additionally, the build material particles 201 may be formed to have dimensions, e.g., widths, diameters, or the like, that are generally between about 5 μm and about 100 μm. In other examples, the build material particles 201 may have dimensions that are generally between about 30 μm and about 60 μm. The build material particles 201 may have any of multiple shapes, for instance, as a result of larger particles being ground into smaller particles.

Forming components 214 may be implemented to deliver an agent onto selected locations on the layers of build material particles 201 to form sections of the 3D object 204 in the successive layers. The forming components 214 may include an agent delivery device or multiple agent delivery devices, e.g., printheads, fluid delivery devices, etc. Thus, although the forming components 214 have been depicted as a single element, it should be understood that the forming components 214 may represent multiple elements. A heating mechanism 203 to apply heat onto the layers of build material particles 201 to form the sections of the 3D object 204 may also be provided in the build chamber 202.

According to examples, the agent may be a fusing agent that may enhance absorption of heat from the heating mechanism 203 to heat the build material particles 201 to a temperature that is sufficient to cause the build material particles 201 upon which the agent has been deposited to melt. In addition, the heating mechanism 203 may apply heat, e.g., in the form of heat and/or light, at a level that causes the build material particles 201 upon which the agent has been applied to melt without causing the build material particles 201 upon which the agent has not been applied to melt.

The forming components 214 may supply multiple types of agents onto the layers build material particles 201. The multiple types of agents may include agents having different properties with respect to each other. In this regard, the processor 207 may control the forming components 214 to supply the agent or a combination of agents that results in the object 204 having certain features. By way of particular example, the multiple types of agents may be different colored inks and the processor 207 may control the forming components 214 to deposit an agent or a combination of agents onto build material particles 201 to form an object 204 having a particular color from those build material particles 201.

The 3D printing system 200 may include an apparatus 205, which may include a processor 207 that may control various operations in the 3D printing system 200, including the spreader 210, the hopper 212, and the forming components 214. The processor 207 may implement operations to control the forming components 214 to form the 3D object 204 in a volume of build material particles 201 contained in the build bucket 206.

The build material particles 201 used to form the 3D object 204 may be composed of build material particles from a fresh supply 220 of build material particles, build material particles from a recycled supply 222 of build material particles, or a mixture thereof. The fresh supply 220 may represent a removable container that contains build material particles that have not undergone any 3D object formation cycles. The recycled supply 222 may represent a removable container that contains build material particles that have undergone at least one 3D object formation cycle and may contain build material particles that have undergone different numbers of 3D object formation cycles with respect to each other. As shown, the build material particles in the fresh supply 220 may be provided into a fresh material hopper 224 and the build material particles in the recycled supply 222 may be provided into a recycled material hopper 226. Additionally, the build material particles in either or both of the fresh material hopper 224 and the recycled material hopper 226 may be supplied to the upper hopper 212, which may include a cyclone separator 102. The build material particles may be provided into the hoppers 224, 226 from the respective supplies 220, 222 prior to implementing a print job to ensure that there are sufficient build material particles to complete the print job.

Generally speaking, the processor 207 may control the mixture or ratio of the fresh build material particles and recycled build material particles that are supplied to the upper hopper 212. The ratio may depend upon the type of 3D object 204 being formed. For instance, a higher fresh build material particle to recycled build material particle ratio, e.g., up to a 100 percent fresh build material particle composition, may be supplied when the 3D object 204 is to have a higher quality, to have thinner sections, have higher tolerance requirements, or the like. Conversely, a lower fresh build material particle to recycled build material particle ratio, e.g., up to a 100 percent recycled build material particle composition, may be supplied when the 3D object 204 is to have a lower quality as may occur when the 3D object 204 is a test piece or a non-production piece, when the 3D object 204 is to have lower tolerance requirements, or the like. The ratio may be user-defined, may be based upon a particular print job, may be based upon a print setting of the 3D printing system 200, and/or the like.

In any regard, the processor 207 may control the ratio of the fresh and the recycled build material particles supplied to the upper hopper 212 through control of respective feeders 228, 230. A first feeder 228 may be positioned along a supply line from the fresh material hopper 224 and a second feeder 230 may be positioned along a supply line 232, which may be equivalent to the feed line 104 depicted in FIGS. 1A and 1B, from the recycled material hopper 226. The first feeder 228 and the second feeder 230 may be rotary airlocks that may regulate the flow of the build material particles from the respective hoppers 224, 226 along a feed line 232 toward the upper hopper 212. The feed line 232 may also be supplied with air from an input device 234 to assist in the flow of build material particles from the hoppers 224, 226 to the upper hopper 212 and cyclone separator 102.

A third feeder 236, which may also be a rotary airlock (which allows forward-flow of powder and restricts back-flow of air), may be positioned along a supply line from the upper hopper 212 to the spreader 210. The upper hopper 212 may include a level sensor (not shown) that may detect the level of build material particles contained in the upper hopper 212. The processor 207 may determine the level of the build material particles contained in the upper hopper 212 from the detected level and may control the feeders 228, 230 to supply additional build material particles in a particular ratio when the processor 207 determines that the build material particle level in the upper hopper 212 is below a threshold level, e.g., to ensure that there is a sufficient amount of build material particles to form a layer of build material particles having a certain thickness during a next spreader 210 pass.

The 3D printing system 200 may also include a collection mechanism 209, which may include a blow box 240, a filter 242, a sieve 244, and a reclaimed material hopper 246. Airflow through the collection mechanism 209 may be provided by a collection blower 248. The collection mechanism 209 may reclaim incidental build material particles 201 from the build bucket 206 as well as from a location adjacent to the build bucket 206 as shown in FIG. 2. Particularly, following formation of the 3D object 204, the build material particles 201 may remain in powder form and the collection mechanism 209 may reclaim the build material particles 201 that were not formed into the 3D object 204. That is, the incidental build material particles 201 may be separated from the 3D object 204 through application of a vacuum force inside the build bucket 206. The collection mechanism 209 may also be vibrated to separate the incidental build material particles 201 from the 3D object 204.

The incidental build material particles 201 in the build bucket 206 may be sucked into the blow box 240 and through the filter 242 and the sieve 244 before being collected in the reclaimed material hopper 246. Additionally, during spreading of the build material particles 201 to form layers on the build bucket 206, e.g., as the spreader 210 moves across the build bucket 206, excess build material particles 201 may collect around a perimeter of the build bucket 206. As shown, a perimeter vacuum 216 may be provided to collect the excess build material particles 201, such that the collected build material particles 201 may be supplied to the collection mechanism 209. A valve 250, such as an electronically controllable three-way valve, may be provided along a feed line 252 from the build bucket 206 and the perimeter vacuum 216. In examples, the processor 207 may manipulate the valve 250 such that particles flow from the perimeter vacuum 216 during formation of the 3D object 204 and flow from the build bucket 206 following formation of the 3D object 204.

A fourth feeder 254, which may also be a rotary airlock, may be provided to feed the reclaimed build material particles 256 contained in the reclaimed material hopper 246 to the upper hopper 212 and/or to a lower hopper 258. The fourth feeder 254 may feed the reclaimed build material particles 256 through the feed line 232. A valve 260, such as an electronic three-way valve, e.g., the valve 260 may be a three-port, two-state valve in which materials may flow in one of two directions), may be provided along the feed line 232 and may direct the reclaimed build material particles 256 to the upper hopper 212 and cyclone separator 102 (which may be positioned in or atop the upper hopper 212) or may divert the reclaimed build material particles 256 to the lower hopper 258, which may also include the cyclone separator 102 discussed with respect to FIGS. 1A and 1B. The processor 207 may also manipulate the valve 260 to control whether the reclaimed build material particles 256 are supplied to the upper hopper 212 or the lower hopper 258. As discussed above, the processor 207 may make this determination based upon the ratio of fresh and recycled build material particles that is to be used to form the 3D object 204. In addition, or in other examples, the cyclone separator 102 in the lower hopper 258 may be implemented to assist in a material changeout in which, for instance, the material in the hoppers 220 and 226 may be emptied into the recycled supply 222 prior to new powder being supplied via the fresh supply 220 and the fresh material hopper 224.

A fifth feeder 262, which may also be a rotary airlock, may be provided to feed the reclaimed build material particles 256 contained in the lower hopper 258 and cyclone separator 102 to the recycled supply 222 and/or the recycled material hopper 226. The processor 207 may control the fifth feeder 262 to feed the reclaimed build material particles 256 into the recycled supply 222 in instances in which the reclaimed build material particles 256 are not to be used in a current build. In addition, the processor 207 may control the fifth feeder 262 to feed the reclaimed build material particles 256 into the recycled material hopper 226 in instances in which the reclaimed build material particles 256 are to be used in a current build.

The 3D printing system 200 may also include a blower 270, which may be equivalent to the air pressure generator 112, that may create suction to enhance airflow through the lines in the 3D printing system 200. The airflow may flow through a filter box 272 and a filter 274 that may remove particulates from the airflow from the upper hopper 212 and the lower hopper 258 prior to the airflow being exhausted from the 3D printing system 200. In other words, the blower 270, filter box 272, and filter 274 may represent parts of the outlets of the cyclone separators 102 in the upper hopper 212 and the lower hopper 258 and may collect particulates that were not removed from the airflow in the cyclone separators 102 connected to the upper and/or lower hoppers 212 and 258.

Although not shown in FIG. 2, the apparatus 205 may also include an interface through which the processor 207 may communicate instructions to a plurality of components contained in the 3D printing system 200. The interface may be any suitable hardware and/or software through which the processor 207 may communicate the instructions. In any regard, the processor 207 may communicate with the components of the 3D printing system 200 as discussed above.

The processor 207 may be a semiconductor-based microprocessor, a central processing unit (CPU), an application specific integrated circuit (ASIC), a field-programmable gate array (FPGA), a graphics processing unit (GPU), a tensor processing unit (TPU), and/or other hardware device. The apparatus 205 may also include a memory 110 that may have stored thereon machine readable instructions (which may also be termed computer readable instructions) that the processor 207 may execute. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory, which may also be referred to as a computer readable storage medium, may be a non-transitory machine-readable storage medium, where the term “non-transitory” does not encompass transitory propagating signals.

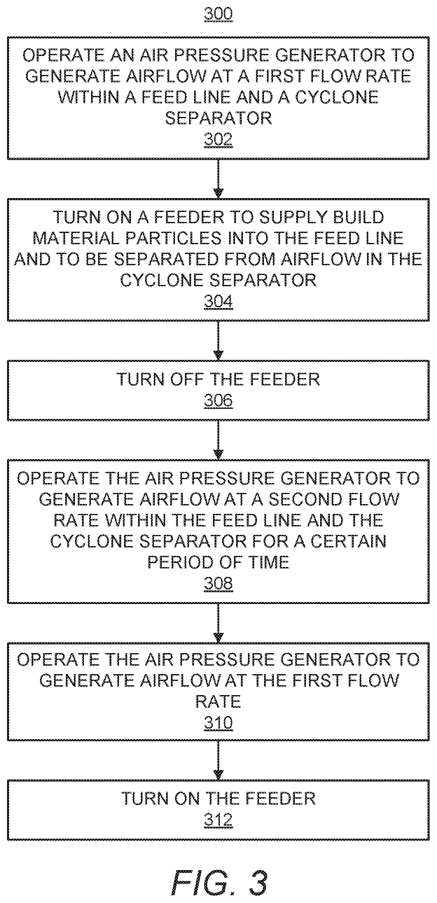

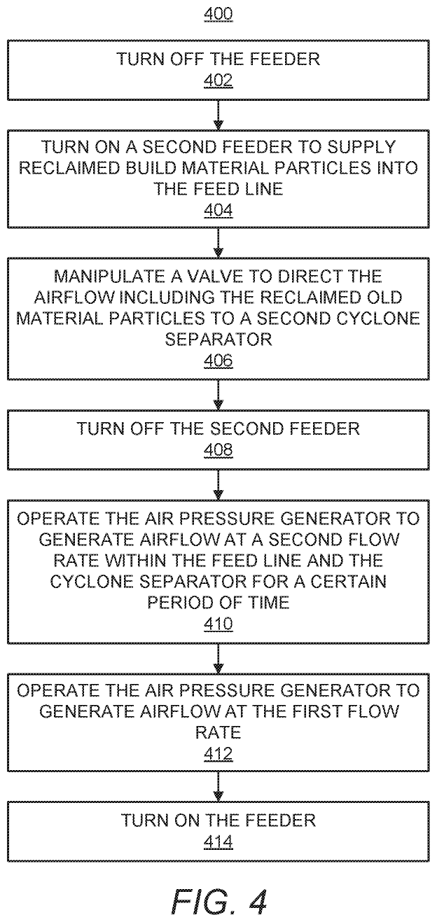

Various manners in which the apparatus 205 and the 3D printing system 200 may be implemented are discussed in greater detail with respect to the methods 300 and 400 respectively depicted in FIGS. 3 and 4. FIGS. 3 and 4, respectively, depict example methods 300 and 400 for moving build material particles within a 3D printing system. Particularly, FIGS. 3 and 4, respective depict example methods 300 and 400 for feeding build material particles to a cyclone separator 102 or to multiple cyclone separators 102 and for clearing out build material particles from the cyclone separator(s) 102. It should be apparent to those of ordinary skill in the art that the methods 300 and 400 may represent a generalized illustration and that other operations may be added or existing operations may be removed, modified, or rearranged without departing from scopes of the methods 300 and 400.

The descriptions of the methods 300 and 400 are made with reference to the apparatus 205, the cyclone separator 102, and the 3D printing system 200 illustrated in FIGS. 1A, 1B, and 2 for purposes of illustration. It should be understood that apparatuses and 3D printing systems having other configurations may be implemented to perform the methods 300 and 400 without departing from scopes of the methods 300 and 400. In any regard, the processor 207 may execute a set of machine readable instructions to execute the methods 300 and 400. In addition, the method 400 may be implemented following the method 300 or may be implemented separately from the method 300.

At block 302, an air pressure generator 112 (e.g., blower 270) may be operated to generate airflow at a first flow rate within a feed line 104, 232 and a cyclone separator 102. At block 304, a feeder 228 to supply build material particles 201 into the feed line 104, 232 may be turned on to supply build material particles 201 into the feed line 104, 232 from a material hopper 224. Turning on the feeder 228 may cause build material particles 201 to mix with the airflow in the feed line 104, 232 and to be delivered into the cyclone separator 102 located in the upper hopper 212 and/or the lower hopper 258. In addition, as discussed above, the cyclone separator 102 may separate the build material particles 201 from the airflow and the separated build material particles 201 may be stored in the upper hopper 212 and/or the lower hopper 258.

At block 306, the feeder 228 may be turned off to stop the supply of material particles into the feed line 104, 232. That is, for instance, the processor 207 may control the feeder 228 to move to a closed position following a predetermined length of time after controlling the feeder 228 to be turned on, e.g., moved to an opened position. The predetermined length of time may be based upon any number of factors, for instance, following completion of a print job, at a set interval of time, under a user direction, etc.

At block 308, the air pressure generator 112, 270 may be operated to generate airflow at a second flow rate within the feed line 104, 232 and the cyclone separator 102. The second flow rate may be significantly higher than the first flow rate and may remove the material particles 201 that have become attached to the cyclone separator 102. The air pressure generator 112, 270 may be operated to generate airflow at the second (greater) flow rate for a certain period of time. The certain period of time may pertain to a length of time that is sufficient to remove the build material particles 201 from interior walls of the cyclone separator 102 and other conduits through which the build material particles 106 have been fed.

At block 310, following the certain period of time, the air pressure generator 112, 270 may be operated to generate airflow at the first flow rate within the feed line 104, 232 and the cyclone separator 102. In addition, at block 312, the feeder 228 may be turned on, e.g., opened, to supply build material particles 201 into the airflow being fed in the feed line 104, 232 and into the cyclone separator 102.

Turning now to FIG. 4, at block 402, the feeder 228 may be turned off. At block 404, a second feeder 230 to supply reclaimed build material particles 201 into the feed line 104, 232 may be turned on to supply reclaimed build material particles 201 into the feed line 104, 232 from a reclaimed material bin 226. Turning on of the second feeder 230 may cause reclaimed build material particles 201 to mix with the airflow in the feed line 104, 232. At block 406, a valve 260 may be manipulated to direct airflow including the reclaimed build material particles 201 to a second cyclone separator 102, for instance, the cyclone separator 102 located in the lower hopper 258. As discussed above, the cyclone separator 102 may separate the build material particles 201 from the airflow and the separated build material particles 201 may be captured in the lower hopper 258.

At block 408, the feeder 230 may be turned off, e.g., stopped, to stop the transfer of reclaimed build material particles 201 into the feed line 104, 232. That is, for instance, the processor 207 may control the feeder 230 to move to a closed position following a predetermined length of time after controlling the feeder 230 to move to an opened position. The predetermined length of time may be based upon any number of factors, for instance, following completion of a print job, at a set interval of time, under a user direction, etc.

At block 410, the air pressure generator 112, 270 may be operated to generate airflow at a second flow rate within the feed line 104, 232 and the cyclone separator 102 in the lower hopper 258. The second flow rate may be significantly higher than the first flow rate and may remove the material particles 201 that have become attached to the cyclone separator 102 and/or other conduits. The air pressure generator 112, 270 may be operated to generate airflow at the second flow rate for a certain period of time. The certain period of time may pertain to a length of time that is sufficient to remove the build material particles 201 from interior walls of the cyclone separator 102.

At block 412, following the certain period of time, the air pressure generator 112, 270 may be operated to generate airflow at the first flow rate within the feed line 104, 232 and the cyclone separator 102. In addition, at block 414, the feeder 230 may be turned on, e.g., opened, to supply build material particles 201 into the airflow being fed in the feed line 104, 232 and into the cyclone separator 102.

Some or all of the operations set forth in the methods 300 and 400 may be contained as utilities, programs, or subprograms, in any desired computer accessible medium. In addition, some or all of the operations set forth in the methods 300 and 400 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A 3D printing system comprising:
a feed line to receive build material particles from a material bin;
an air pressure generator to generate airflow inside the feedline to move the build material particles through the feedline; and
a cyclone separator to receive the airflow and the build material particles from the feed line and to separate the build material particles from the airflow, the cyclone separator comprising a chamber wall, a build material particle discharge opening, and a tapered wall connecting the chamber wall and the build material particle discharge opening, wherein a ratio between a diameter of the chamber and a diameter of the discharge opening is between about 1.5 and about 4.0.

2. The 3D printing system according to claim 1, wherein the cyclone separator further comprises an airflow exhaust member having a hole and an end cap spaced from the hole, the airflow exhaust member extending into a chamber formed by the chamber wall, and the airflow exhaust member including a plurality of apertures positioned between the hole and the end cap.

3. The 3D printing system according to claim 2, wherein the end cap extends perpendicularly to the plurality of apertures and includes a conical shape having a point, wherein the point of the end cap faces away from the build material particle discharge opening.

4. The 3D printing system according to claim 2, wherein a ratio between the diameter of the chamber and a diameter of the hole in the airflow exhaust member is between about 2 and about 4.

5. The 3D printing system according to claim 1, wherein a ratio between a height of the chamber wall and a height of the tapered wall is between about 0.7 and about 1.5.

6. The 3D printing system according to claim 1, wherein the build material particle discharge opening is between about 20 mm and about 40 mm.

7. The 3D printing system according to claim 1, further comprising:
a build area; and
an upper hopper positioned beneath the cyclone separator to receive build material particles discharged from the cyclone separator, the upper hopper to supply the build material particles in the build area.

8. The 3D printing system according to claim 1, further comprising a second cyclone separator to receive airflow and reclaimed build material particles from a reclaimed material hopper, wherein the second cyclone separator is to separate the reclaimed build material particles from the airflow and to supply the reclaimed build material particles into a recycled material bin.

9. The 3D printing system according to claim 1, further comprising:
a feeder positioned between the material bin and the feed line; and
a controller to control a volume of build material particles supplied into the feed line through manipulation of the feeder.

10. The 3D printing system according to claim 1, wherein the cyclone separator is formed of a material that is at least one of anti-static, electrically conductive, and triboelectrically similar to the build material particles.

11. A cyclone separator comprising:
a chamber wall surrounding a chamber having a first diameter;
a discharge opening for particles, the discharge opening having a second diameter, the second diameter being smaller than the first diameter by a ratio of between about 1.5 and about 4.0;
a tapered wall connecting the discharge opening to the chamber wall;
an airflow exhaust member having a first end that extends into the chamber, the first end including an end cap and a plurality of apertures extending along the airflow exhaust member, the end cap having a conical shape that extends away from the discharge opening.

12. The cyclone separator according to claim 11, wherein a ratio between the first diameter of the chamber and a diameter of a hole in the airflow exhaust member is between about 2 and about 4 and wherein a ratio between a height of the chamber and a height of the tapered wall is between about 0.7 and about 1.5.

13. A method comprising:
operating an air pressure generator to generate airflow at a first flow rate within a feed line and a cyclone separator;
turning on a feeder to supply build material particles into the feed line from a material bin to mix with the airflow and to be separated from the airflow in the cyclone separator;
turning off the feeder to stop the supply of build material particles into the feed line;
operating the air pressure generator to generate airflow at a second flow rate within the feed line and the cyclone separator for a certain period of time to remove build material particles that are attached to the cyclone separator and other conduits through which the build material particles are fed; and
following the certain period of time,
operating the air pressure generator to generate airflow at the first flow rate within the feed line and the cyclone separator; and
turning on the feeder.

14. The method according to claim 13, further comprising:
turning off the feeder;
turning on a second feeder to supply reclaimed build material particles into the feed line from a reclaimed material hopper;
manipulating a valve to direct the airflow including the reclaimed build material particles to a second cyclone separator that is to separate the reclaimed build material particles from the airflow and to supply the reclaimed build material particles into a recycled material hopper.

15. The method according to claim 14, further comprising:
turning off the second feeder to stop the supply of reclaimed build material particles into the feed line; and
operating the air pressure generator to generate airflow at the second flow rate within the feed line and the second cyclone separator for a certain period of time to remove reclaimed build material particles that are attached to the second cyclone separator and the other conduits; and
following the certain period of time,
operating the air pressure generator to generate airflow at the first flow rate within the feed line and the cyclone separator; and
turning on the second feeder.
